(19) United States
(12) Patent Application Publication
(10) Pub. No.: US 2019/0102665 A1
(43) Pub. Date: Apr. 4, 2019

(54) METHOD OF MANUFACTURING A SMARTCARD

(71) Applicant: Zwipe AS, Oslo (NO)

(72) Inventors: Devin SNELL, Monument, CO (US); Jose Ignacio Wintergerst LAVIN, Colorado Springs, CO (US)

(21) Appl. No.: 16/085,792

(22) PCT Filed: Mar. 24, 2017
(86) PCT No.: PCT/EP2017/057107

§ 371 Date: Sep. 17, 2018

Related U.S. Application Data
(60) Provisional application No. 62/312,803, filed on Mar. 24, 2016.

(30) Foreign Application Priority Data
Apr. 22, 2016 (GB) 1607030.2

(51) Int. Cl. G06K 19/077; G06K 19/07; G06K 19/02

(52) U.S. Cl. CPC G06K 19/07747; G06K 19/07743; G06K 19/025; G06K 19/0718; G06K 19/07769

(57) ABSTRACT

A method of manufacturing a smartcard includes providing a flexible circuit having contacts for connection to a contact pad, wherein a secure element is electrically connected to the flexible circuit, electrically connecting contacts on the contact pad to the contacts on a flexible circuit via conductive paths through an extension block. A lamination process is applied to the flexible circuit to provide a card body enclosing the flexible circuit.

The present invention relates to a smartcard and to its method of manufacture, and more particularly to the manner in which a component to be exposed from the smartcard is mounted to an embedded circuit board of the smartcard during manufacture.

The term smartcard refers generally to any pocket-sized card that has one or more integrated circuits embedded therein. Examples of common smartcard applications include payment cards, access cards, and the like.

The contact pad is the designated surface area of the smartcard that permits electrical contact to be made with an external device. Where the smartcard contains sensitive data, such as in the case of payment cards and the like, a secure element is used to store and process the data. A secure element is a tamper-proof chip that provides a secure memory and execution environment in which application code and application data can be securely stored and administered. The secure element ensures that access to the data stored on the card is provided only when authorised. In conventional smartcards, the secure element is mounted to the back of the contact pad such that the contact pad and secure element form a single unit. The combined unit, including both a contact pad and a secure element, is often referred to as a contact module.

Recent developments in smartcard technology have allowed for the incorporation of biometric sensors, such as fingerprint sensors, into smartcards to provide improved security. The biometric sensor reads detected biometric data and supplies this to a microcontroller for user verification, and once verified the microcontroller instructs or allows the secure element to communicate with a payment terminal or the like through the contact pad. This requires the biometric module to communicate directly with the secure element. However, the secure element in a conventional contact module is fully enclosed and there is no easy way of interacting.

Thus, where the smartcard includes additional security measures, such as the biometric authentication described above, it has been found to be advantageous to configure the contact pad and secure element separately within the smartcard, i.e. such that each component occupies its own “real estate” on the circuit board of the smartcard. This arrangement permits simpler control of the secure element by a biometric authentication module. For example, in low security applications, a simple switch controlled by the biometric authentication module can be provided between the secure element and the contact pad to permit or disable communication. However, this configuration also gives rise to manufacturing difficulties.

Viewed from a first aspect, the present invention provides a smartcard comprising: a card body enclosing a flexible circuit; a contact pad having contacts exposed from the card body; an extension block located within the card body between the contact pad and the flexible circuit, the extension block defining conductive paths therethrough such that the contacts of the contact pad are electrically connected to the contacts on the flexible circuit via the conductive paths; and a secure element located within the card body and electrically connected to the flexible circuit, wherein the secure element does not overlap with the contact pad.

In this smartcard, the contact pad is raised off of the flexible circuit in order for it to be exposed at the correct height from the card body, whilst still electrically connecting the contact pad to the circuit, by the extension block. Thus, the outer surface of the contact pad is preferably flush with the outer surface of the smartcard, with the extension block ensuring the correct spacing between the contact pad and the circuit as well as providing the electrical connection. This configuration thus allows a secure element to be located elsewhere than directly behind the contact pad, thereby permitting simpler interface between the secure element and other components within the smartcard.

Whilst the above embodiment relates to a contact pad, it will be appreciated that the same configuration may also be employed for other elements that are required to be connected to the flexible circuit and exposed from the body of the smartcard.

The thickness of the smartcard is preferably about 30 mil (˜762 μm), which is the thickness for a smartcard defined by ISO/IEC 7816. Similarly, the smartcard preferably has a height of 3.375 in (˜86 mm) and a width of 2.125 in (˜54 mm), which are again the dimensions for a smartcard defined by ISO/IEC 7816.

In various configurations, the extension block may have a height of at least 200 μm, and preferably at least 300 μm. Preferably, the height of the extension member is between 350 μm and 450 μm. The extension block preferably has a height of less than 762 μm, i.e. the thickness of an ISO/IEC 7816 smartcard, and preferably less than 500 μm.

The extension block may take various forms. For example, in one embodiment, the extension block comprises a block of electrically-insulating material defining a plurality of conductive paths. The extension block may comprise through holes, wherein conductive paths extend through the through holes. For example, the conductive paths may be defined by conductive plating formed on the walls of the through holes. In this configuration, the body of the material provides support for the contact pad whilst insulating the conductive paths from one another.

In one arrangement, separate contacts may be provided adjacent or over the through holes for connection to the contacts of the contact pad and/or flexible circuit. The contacts may be positioned to cover the through holes so that the conductive paths extend through the extension block from one contact to another contact. Alternatively the contacts may be positioned so as not to cover the through holes and are electrically connected to the conductive paths to form an electrical connection between one contact and another contact. Alternatively, or in addition, the through holes may be filled by a conductive material, such as a metallic solder or a conductive epoxy.

The extension block may be electrically connected to the contacts of the flexible circuit and/or the contacts of the contact pad by any suitable means. For example, the electrical connection to the flexible circuit and/or the contact pad may comprise any one of a mechanical connection (such as via surface mount technology), a conductive adhesive connection, and a metallic solder connection.

A formation temperature (e.g. a curing temperature, or a melting temperature, or a reflow temperature) of the electrical connection may be lower than a melting temperature of the material of the card body. Thus, forming the electrical connection will not cause deformation of the card. In one embodiment, the electrical connection may have a formation temperature below 150° C., and preferably below 140° C.

In order to ensure sufficient longevity of the card, it is necessary to be aware of the temperature sensitivity of the materials used typically for smartcards, which do not allow for traditional soldering. For example, most typical solders must be heated to temperatures of over about 240° C. to become molten, whereas polyvinyl chloride (PVC), which is the most common material used to produce laminated cards, has a melting temperature of only 160° C. (and a glass transition temperature of only 80° C.). Polyurethane (PU), which is also commonly used as filler for laminated cards, would also be damaged by exposure to temperatures in the region of 240° C.

Where the contact pad and/or extension block are added after lamination, to avoid overheating the card body materials, the above smartcard may use a low temperature material to conductively join the contact pad and the flexible circuit to the extension block. The use of a low temperature electrical connection avoids any physical deformation of the card material. Alternatively, the contact pad and the extension block may be electrically connected whilst not in the vicinity of the card material, i.e. whilst not in situ within the card body. This avoids any physical deformation of the card material whilst negating the need to use a low temperature electrical connection.

The electrical connection may comprise a conductive adhesive, and the conductive adhesive may have a curing temperature below the melting temperature of the material forming the card body. Exemplary conductive adhesives include conductive epoxies, and in one preferred embodiment the connection comprises an anisotropic conductive film (ACF). However, other non-melting conductive resins may of course be used to provide the electrical connections.

The electrical connection may comprise a mechanical connection such as a connection via surface mount technology which does not typically require heating. This has the advantage of not requiring thermal or physio-chemical processes, and enables room temperature manufacturing with no preparation or wait times. One exemplary mechanical connection is an elastomeric connector (sometimes known as a Zebra connector®). The elastomeric connector comprises mated male and female terminals, each having alternating conductive and non-conductive stages that engage the respective stages of the corresponding terminal.

In another example, the mechanical connection may comprise embedded conductive stubs that are configured to deform so as to conform to the surface of the extension block. For example, in one configuration, the stubs may be configured to press into the through holes formed in the extension block, for example so as to electrically connect with the plating formed on the surfaces thereof. The stubs may be made of, for example, carbon or silver or copper. Alternatively, the stubs may be formed of a solder material such that they can be pressed into engagement (e.g. into the through holes) and then heated to cause the solder to reflow forming a permanent connection.

Where the electrical connection comprises a solder connection, a solder material forming the solder connection may have a reflow temperature below the melting temperature of the material forming the card body, and in various embodiments a melting temperature of the solder material may also be below the melting temperature of the material forming the card body.

If a solder material is used, the solder material may be a tin-bismuth solder. Such solders have typical melting temperatures of approximately 139° C. This is below the 160° C. melting temperature of PVC.

The use of a metallic solder material allows for the card to employ a metal-to-metal connection between the contact pad and the flexible circuit, which provides high durability to provide maximum life to the smartcard—a typical payment card, for example, must have a minimum lifetime of three years.

If either a solder or a conductive adhesive is used, the solder or conductive adhesive may at least partially fill the through holes in the extension block, and in one embodiment may form a continuous connection between the contacts of the contact pad and the flexible circuit via the through holes.

One or more components in addition to the contact pad may also be connected to the flexible circuit. These components may be embedded within the card body (e.g. attached before a lamination process) or may be exposed from the card body.

For example, the secure element may be connected to the flexible circuit. The secure element is preferably embedded within the card body. The flexible circuit may be arranged to permit communication between a secure element and the contact pad via the extension block. As discussed above, the circuit is preferably arranged such that the secure element does not overlap with a contact pad connected to the extension block (i.e. viewed in a direction perpendicular to the face of the smartcard).

In another example, a biometric authentication module may be connected to the flexible circuit. The biometric authentication module may be configured to detect a biometric characteristic of a bearer of the card and authenticate their identity based on stored biometric data. The biometric authentication module may be configured to command the secure element of the smartcard to transmit data responsive to authentication of the bearer of the card. In one particular embodiment, the biometric is a fingerprint.

The biometric authentication module may be attached before or after the lamination, or a combination of the two. For example, the biometric authentication module may include a processing unit and a biometric sensor. The processing unit of the biometric authentication module may be embedded within the card body (i.e. it was connected to the circuit before a lamination process or the like) and the sensor of the biometric authentication module may be exposed from the card body. This arrangement prevents damage to the sensitive components within the sensor due to the high pressure and temperatures experienced during lamination or other manufacturing techniques.

The circuit is preferably arranged to permit communication between the biometric authentication module (and particularly the processing unit thereof) and the secure element and/or the contact pad. In another embodiment, the circuit may include a switch to permit or prevent communication between the secure element and an external device (e.g. the switch may be located between the secure element and the contact pad). The circuit is then preferably arranged to permit the biometric authentication module (and particularly the processing unit thereof) to control the switch.

In addition to the contact pad, the smartcard may further comprise an antenna. The antenna is preferably configured to communicate with the secure element. Thus, the smartcard may permit both contact transactions and contactless transactions.

The smartcard may include a near field communication (NFC) transponder connected to the antenna. The smartcard preferably may include energy harvesting circuitry which is configured to rectify a received RF signal and store energy using an energy storage component within the smartcard.

The card body may be formed from a plastics material, and preferably PVC and/or PU. For example, the card body may comprise a PVC layer on either side of the flexible circuit with an intermediate layer between the PVC layers. The intermediate layer may comprise a plastics material such as PVC or PU.

In various embodiments, the flexible circuit is a flexible printed circuit board, which is preferably printed on a plastics material. The plastics material preferably has a melting temperature above the lamination temperature and/or will not be damaged by the lamination. Exemplary plastics materials include polyimide, polyester and polyether ether ketone (PEEK).

Viewed from a second aspect, the present invention provides a method of manufacturing a smartcard comprising: providing a flexible circuit having contacts for connection to a contact pad and configured for connection to a secure element; electrically connecting contacts on a contact pad to the contacts on the flexible circuit board via conductive paths through an extension block; electrically connecting a secure element to the flexible circuit board such that the secure element does not overlap with the contact pad; and applying a lamination process to the flexible circuit to provide a card body enclosing the flexible circuit.

Electrically connecting the contacts on the contact pad to the contacts on the flexible circuit board via the paths of the extension block before the lamination process avoids any physical deformation of the card material.

In various embodiments, the smartcard is a smartcard as described in the first aspect, and any one or more or all of the preferred features thereof may apply also this method.

As discussed above, various forms of electrical connection may be used to connect either or both of the contacts to the extension block. For example, the electrical connection(s) may be any one of a mechanical connection, a conductive adhesive connection, a metallic solder connection, or combinations thereof.

Where the electrical connection uses a conductive adhesive, the method may comprise applying a conductive adhesive to one or more or all of the contacts of the contact pad, either or both sides of the extension block, and the contacts of the flexible circuit. The conductive adhesive may comprise a conductive epoxy, and is preferably an anisotropic conductive film (ACF).

Where the electrical connection uses a mechanical connection, one or more extension blocks, the contact pad, the flexible circuit and the card body may be provided with mechanical connections. The step of electrically connecting thus preferably comprises mechanically electrically connecting the contact pad to the extension block and/or mechanically electrically connecting the extension block to the flexible circuit or the card body.

In one embodiment, the extension block comprises holes and the mechanical connection comprises conductive projections formed on the contacts of one or both of the flexible circuit and the contact pad. The step of mechanically electrically connecting may then comprise press-fitting the projections into the holes of the extension block. Optionally the holes may be through holes, although alternatively they could be electrically connected blind holes. In one arrangement, the holes have a conductive lining, such that the mechanically connection electrically connects the conductive projections to the conductive lining to create the electrical connection between the contact pad and the circuit. Optionally, the conductive projections may be formed from a solder material.

Where the electrical connection uses a solder connection, the step of electrically connecting preferably comprises heating a solder material to cause it to reflow and form the electrical connection. The reflow temperature of the solder is preferably a temperature above the melting temperature of the material forming the card body. In one arrangement, the extension block comprises through holes and the method comprises causing the solder to form an electrically connection between the contacts of the contact pad and the contacts of the flexible circuit through the through holes.

Applying a lamination process to the flexible circuit may comprise sandwiching the flexible circuit between laminate sheets to form a pre-lamination card body. The flexible circuit may be encased in an intermediate layer before being sandwiched between the laminate sheets. The laminate sheet covering the surface of the contact pad may be die-cut before lamination to form a hole exposing the contact pad. The pre-lamination card body may be compressed and heated to form a single laminated card body.

The lamination process may take place at temperatures above about 150° C. Typical lamination temperatures are often below 200° C. For example, in one embodiment, the lamination may take place at a temperature between 160° C. and 190° C.

The card body may be formed from a plastics material suitable for thermal lamination. For example, the card body may comprise one or more layers of PVC and/or PU. In one embodiment, the card body comprises an outer layer (e.g. a PVC layer) on either side of the flexible circuit with an intermediate layer between the outer layers. The intermediate layer may comprise a plastics material such as PVC or PU, or other materials such as silicone. The intermediate layer may comprise a liquid or semi-solid/pelletized material.

The method may comprise the step of exposing the contact pad on the surface of the card body. This may comprise removing lamination material from the card body so that the contact pad is exposed. The removal of the lamination material may be performed by any suitable process, such as milling. Removal of material may be necessary to ensure good electrical contact between the contact pad and a card reader. Even if a hole is made in the laminate sheet before the lamination process, the lamination material may melt over the contact pad during the lamination process, forming a thin layer of lamination material over the contact pad. This thin layer of lamination material may be removed as discussed above.

In some embodiments, a secure element may be connected to the flexible circuit. In this case, the secure element is preferably connected before a lamination process, i.e. such that it is enclosed within the card body.

In some embodiments, a biometric authentication module may be connected to the flexible circuit. The biometric authentication module may be attached before or after the lamination process, or a combination of the two. For example, the biometric authentication module may include a processing unit and a biometric sensor. The processing unit of the biometric authentication module may be connected to the circuit before the lamination and the sensor may be installed after lamination.

Viewed from a third aspect, the present invention provides a method of manufacturing a smartcard comprising: providing a card body enclosing a flexible circuit having contacts for connection to a contact pad, wherein a secure element is located within the card body and electrically connected to the flexible circuit, and wherein a cavity is formed in the card body exposing the contacts; inserting into the cavity an extension block that defines paths therethrough and a contact pad having contacts; and electrically connecting the contacts on the contact pad to the contacts on the flexible circuit via the paths of the extension block.

The step of electrically connecting the contacts may take place at a temperature below the melting temperature of the material forming the card body. The paths may be conductive paths or through holes to be filled by conductive material.

The extension block and the contact pad may be electrically connected before insertion into the cavity. This avoids any physical deformation of the card material and thus may take place at a temperature above the melting temperature of the material forming the card body. The extension block may be electrically connected to the contacts of the contact pad by any suitable means. For example, the electrical connection to the contact pad may comprise any one of a mechanical connection (such as via surface mount technology), a conductive adhesive connection, and a metallic solder connection.

In various embodiments, the smartcard is a smartcard as described in the first aspect, and any one or more or all of the preferred features thereof may apply also this method.

As discussed above, various forms of electrical connection may be used to connect either or both of the contacts to the extension block. For example, the electrical connection(s) may be any one of a mechanical connection, a conductive adhesive connection, a metallic solder connection, or combinations thereof. In one embodiment, the step of electrically connecting the contact pad and the flexible circuit may take place at a temperature below 150° C., and preferably below 140° C.

Where the electrical connection uses a conductive adhesive, the method may comprise applying a conductive adhesive to one or more or all of the contacts of the contact pad, either or both sides of the extension block, and the contacts of the flexible circuit. This step preferably takes place before inserting the contact pad into the cavity. The method preferably further comprises curing the conductive adhesive at a temperature below the melting temperature of the material forming the card body. The conductive adhesive may comprise a conductive epoxy, and is preferably an anisotropic conductive film (ACF).

Where the electrical connection uses a mechanical connection, one or more the extension block, the contact pad, the flexible circuit and the card body may be provided with mechanical connections. The step of electrically connecting thus preferably comprises mechanically electrically connecting the contact pad to the extension block and/or mechanically electrically connecting the extension block to the flexible circuit or the card body. The step preferably takes place at approximately ambient temperature.

In one embodiment, the extension block comprises holes and the mechanical connection comprises conductive projections formed on the contacts of one or both of the flexible circuit and the contact pad. The step of mechanically electrically connecting may then comprise press-fitting the projections into the holes of the extension block. Optionally the holes may be through holes, although alternatively they could be electrically connected blind holes. In one arrangement, the holes have a conductive lining, such that the mechanical connection electrically connects the conductive projections to the conductive lining to create the electrical connection between the contact pad and the circuit. Optionally, the conductive projections may be formed from a solder material.

Where the electrical connection uses a solder connection, the step of electrically connecting preferably comprises heating a solder material to cause it to reflow and form the electrical connection. The heating is preferably to a temperature below the melting temperature of the material forming the card body. Electrically connecting the contact pad to the flexible circuit may use ultrasonic soldering, i.e. wherein ultrasound energy is used to melt the solder material. Using an ultrasonic heating process will cause the solder to reflow at lower temperatures than if heat alone were to be applied. In one arrangement, the extension block comprises through holes and the method comprises causing the solder to form an electrical connection between the contacts of the contact pad and the contacts of the flexible circuit through the through holes.

Providing the card body may comprise removing material from the card body to create the cavity and expose the contacts of the flexible circuit. Preferably, the step of removing material comprises removing sufficient that the contact pad does not project beyond the surface of the card body when the contact pad and the extension block are received therein.

The step of removing material may include removing material from the contacts of the circuit to create a flat, contact surface for connection with the contact pad or the extension block. This is particularly useful where a soldered or adhesive connection is to be made to ensure a good electrical connection.

The step of removing material preferably does not expose the flexible circuit, i.e. only the contacts are exposed.

The removal of material may be performed by any suitable process, such as milling. It should be noted that although milling is described, any suitable method of forming the cavity may be used. For example, the cavity may instead be chemically etched in the card body and/or may be at least partially formed before/during the lamination process.

The step of removing material may be performed after the card has been laminated or before lamination, e.g. in case the components are already in place. In alternative embodiments, the card body may be formed in a manner such that removal of material is not required to form the cavity. For example, the cavity may be cut before lamination of the card, or may be moulded during a lamination process. For example, the laminate sheets may die-cut before lamination to avoid a lengthier milling process.

Providing the card body may comprise forming the card body. In one embodiment, the card body is formed by a thermal lamination process. The thermal lamination process may take place at temperatures above about 150° C. Typical lamination temperatures are often below 200° C. For example, in one embodiment, the lamination may take place at a temperature between 160° C. and 190° C.

The card body may be formed from a plastics material suitable for thermal lamination. For example, the card body may comprise one or more layers of PVC and/or PU. In one embodiment, the card body comprises an outer layer (e.g. a PVC layer) on either side of the flexible circuit with an intermediate layer between the outer layers. The intermediate layer may comprise a plastics material such as PVC or PU, or other materials such as silicone. The intermediate layer may comprise a liquid or semi-solid/pelletized material.

In some embodiments, a secure element may be connected to the flexible circuit. In this case, the secure element is preferably connected before a lamination process, i.e. such that it is enclosed within the card body.

In some embodiment, a biometric authentication module may be connected to the flexible circuit. The biometric authentication module may be attached before or after the lamination process, or a combination of the two. For example, the biometric authentication module may include a processing unit and a biometric sensor. The processing unit of the biometric authentication module may be connected to the circuit before the lamination and the sensor may be installed after lamination.

Certain preferred embodiments of the present invention will now be described in greater detail, by way of example only and with reference to the accompanying drawings, in which:

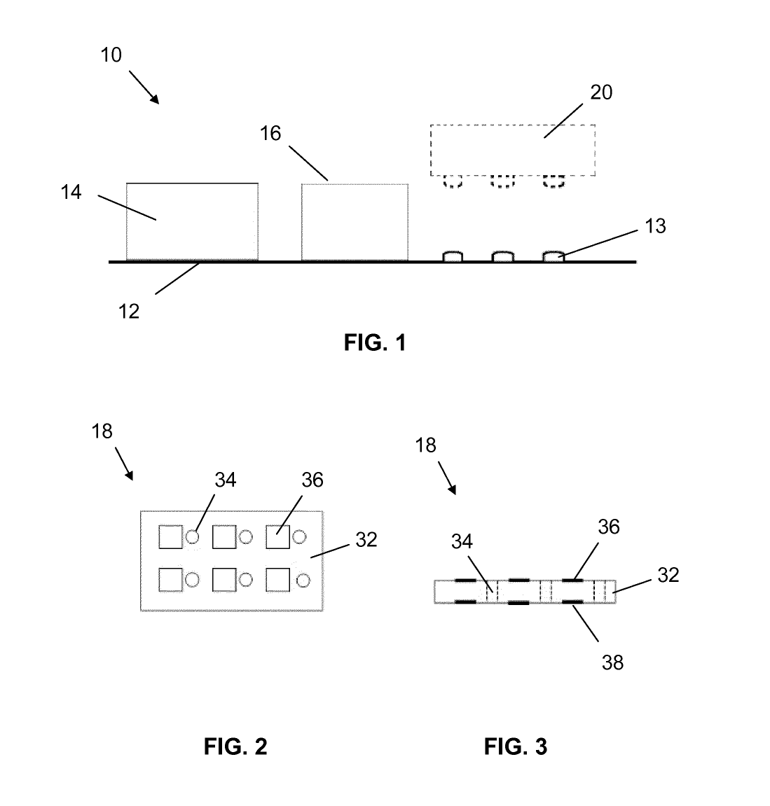

FIG. 1 illustrates a flexible printed circuit board assembly for a smartcard;

FIGS. 2 and 3 illustrate a top view and a side view, respectively, of an extension member for connecting a contact pad of the smartcard to the flexible printed circuit board assembly;

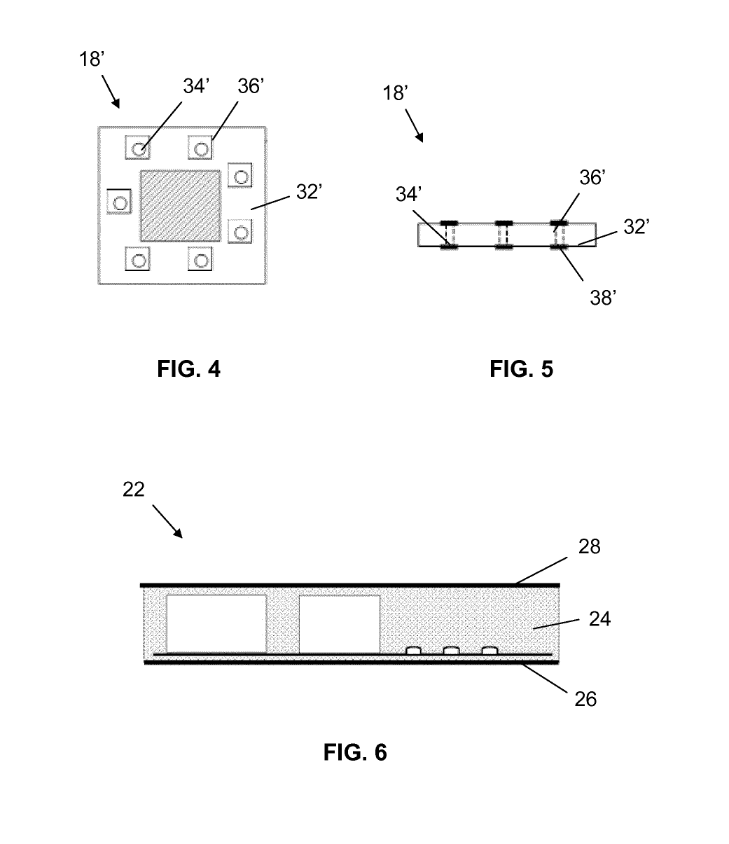

FIGS. 4 and 5 illustrate a top view and a side view, respectively, of an alternative extension member for connecting the contact pad of the smartcard to the flexible circuit board assembly;

FIGS. 6 to 10 illustrate the steps of a first method of mounting a contact pad to the flexible printed circuit board assembly in a smartcard;

FIG. 11 illustrates a smartcard manufactured by this method;

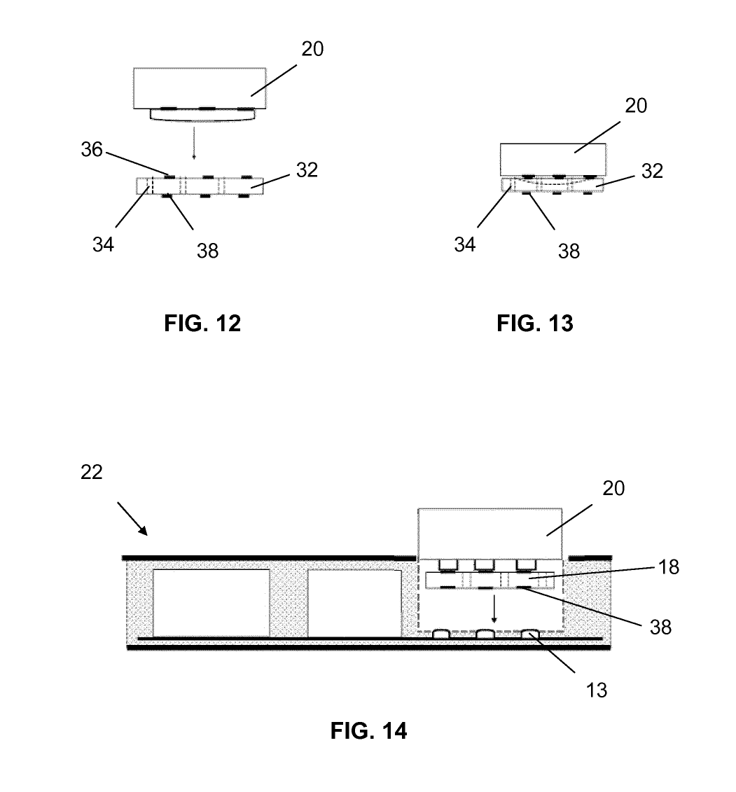

FIGS. 12 to 14 illustrate steps of a second method of mounting a contact pad to the flexible printed circuit board assembly in a smartcard;

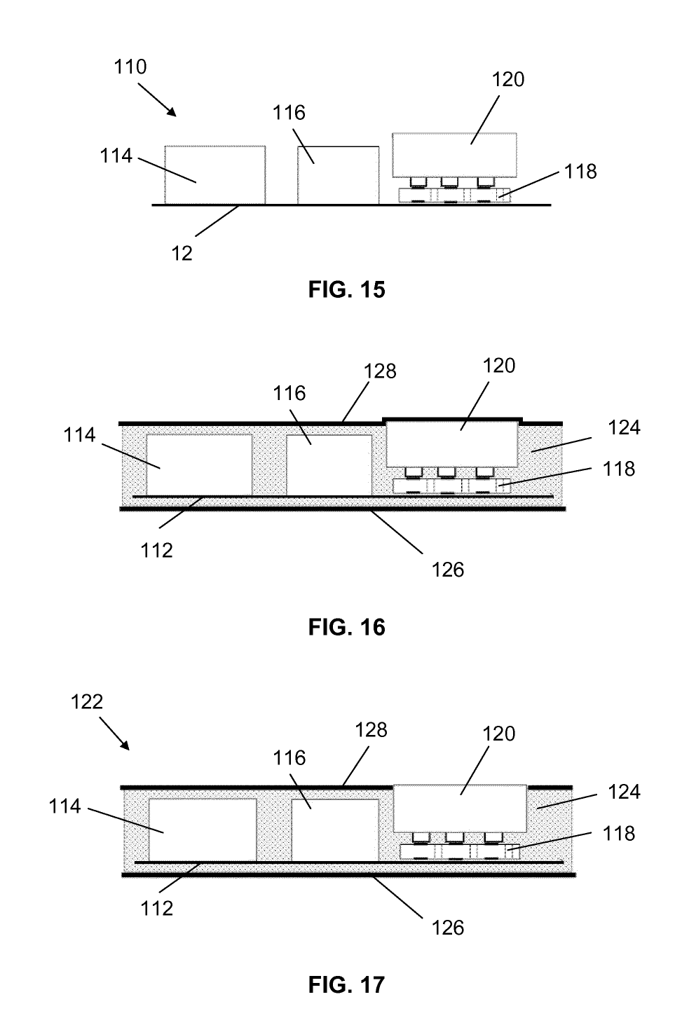

FIGS. 15 to 17 illustrate steps of a third method of mounting a contact pad to the flexible printed circuit board assembly in a smartcard.

It should be noted that for clarity the thicknesses of the various parts shown in FIGS. 1 to 10 and 12 to 17 have been exaggerated significantly. In implementations of smartcards of the type illustrated in the Figures, the width of the card might be about 86 mm whereas the thickness of the card would be less than 1 mm. A total thickness between the outer surfaces of 762 μm is typical, based on ISO standards.

FIG. 1 illustrates a flexible printed circuit board assembly (FPCBA) 10 for a smartcard 102. The circuit board assembly 10 comprises a flexible printed circuit board 12 on which are mounted various components to be embedded within the smartcard 102. These components should each be capable of withstanding the temperatures and pressures arising during a thermal lamination process, such as that described later.

Illustrated in FIG. 1 are a secure element 14 and a fingerprint processing unit 16, which are both connected to the flexible circuit board 12. However, in various embodiments, one or other of these may not be present, and/or further components may also be present.

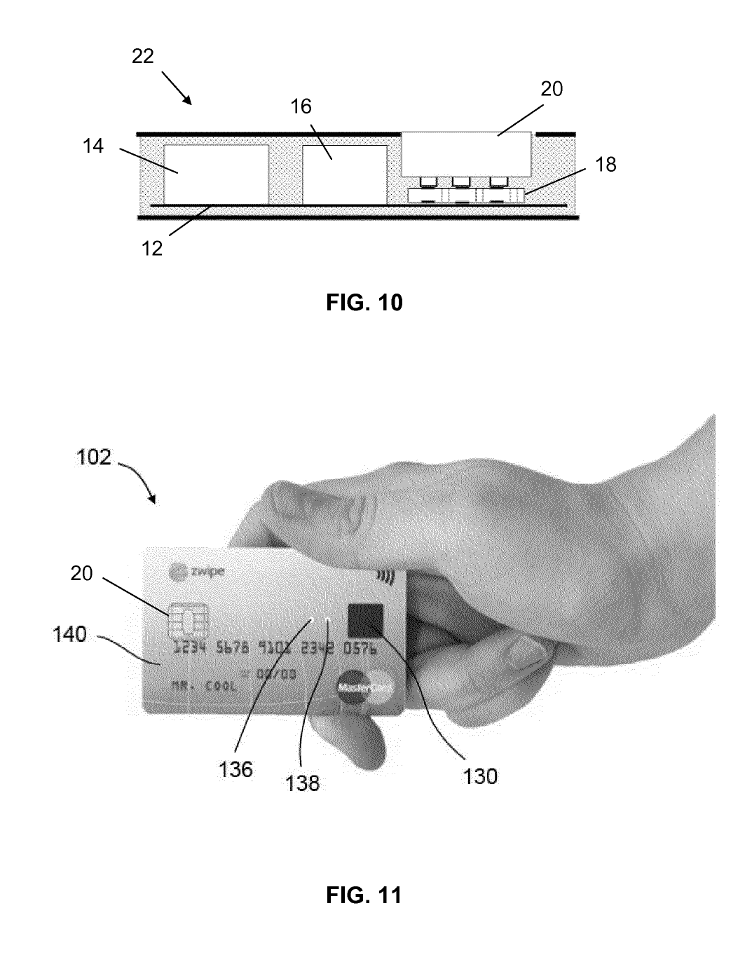

The fingerprint processing unit 16 will form part of a fingerprint authentication module, when connected to a fingerprint sensor 130, such as the area fingerprint reader 130 shown in FIG. 10. The processing unit 16 comprises a microprocessor that is chosen to be of very low power and very high speed, so as to be able to perform biometric matching in a reasonable time.

The fingerprint authentication engine is arranged to scan a finger or thumb presented to the fingerprint reader 130 and to compare the scanned fingerprint of the finger or thumb to pre-stored fingerprint data using the processing unit 16. A determination is then made as to whether the scanned fingerprint matches the pre-stored fingerprint data.

If a match is determined, then the fingerprint authentication engine will authorise the secure element 14 to transmit data from the card via a contact pad 20 (shown in phantom on FIG. 1). On the FPCBA 10 are formed a plurality of electrically-conductive contacts 13 to which the contact pad 20 will be connected via an extension block 18.

FIGS. 2 and 3 show the extension block 18. The extension block 18 will extend away from the flexible circuit board 12 in a direction that is generally perpendicular to the face of the smartcard 102. The extension block 18 has a height of about 300 μm to 400 μm.

The extension block 18 is formed from an electrically insulating member 32 in which are formed through holes 34. The through holes 34 extend from one face of the extension block 18 to the other. The through holes 34 are lined with a conductive lining so as to conduct electricity from one face of the extension block 18 to the other.

On each face of the extension block 18 is formed a plurality of contacts 36, 38. The contacts 36 formed on the upper surface of the extension block are configured to correspond to contacts 21 of the contact pad 20. The contacts 38 formed on the lower surface of the extension block 18 are configured to correspond to contacts 13 of the FPCBA 10. Each of the contacts 36 on the upper surface is electrically connected via one of the through holes 34 to one of the contacts 38 on the lower surface. Thus, when the contact pad 18 is connected to the contacts 13 of the circuit board 12 and to the contacts 21 of the contact pad 20, the contact pad 20 will be electrically connected to the circuit board 12.

The contacts 36, 38 may be formed adjacent the through holes 34 as shown in FIG. 2. Alternatively, the through holes 34′ may be positioned in the centre of the contacts 36′, 38′ so that the through holes extend from a contact 38′ on the lower surface to a contact 26′ formed on the upper surface, as shown in FIGS. 4 and 5.

In accordance with a first method of manufacture, a laminated card body 22 is initially formed. To form the main body 22 of the smartcard 102, the FPCBA 10 is encased in polyurethane (PU) filler 24 and is sandwiched between two polyvinyl chloride (PVC) sheets 26, 28. The two PVC sheets 26, 28 each have a thickness of approximately 80 μm and the intermediate layer formed by the FPCBA 10 and the PU filler 24 has a thickness of approximately 540 μm. The pre-laminated card body is then compressed and heated to a temperature between 160° C. and 190° C. to form a single, laminated card body 22. The laminated card body 22 is illustrated in FIG. 6.

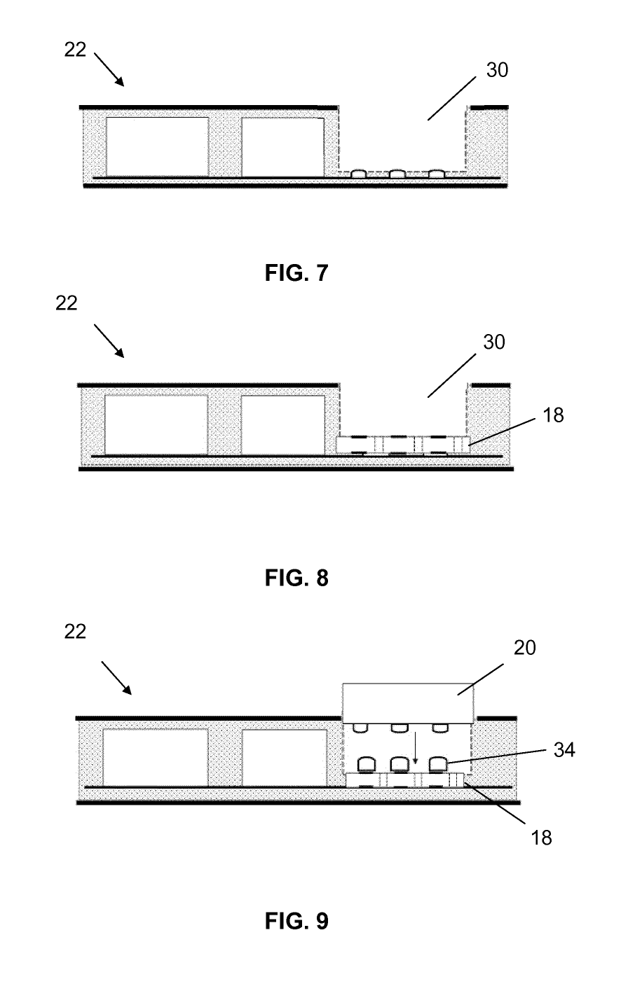

Next, a cavity 30 is milled into the laminated card body 22. The cavity 30 is milled to a depth sufficient to receive the extension block 18 and the contact pad 20 such that the surface of the contact pad 20 will be flush with the surface of the card body 22. The milling also cuts into the contacts 13 of the FPCBA 10 such that the contacts are flattened to form uniform, flat surfaces to which the extension block 18 can be attached. The cavity 30 is illustrated in FIG. 7.

In order to install the extension block 18 into the smartcard, a tin-bismuth solder is used to form solder blobs on the rear contacts 38 of the extension block 18. The extension block 18 is then inserted into the cavity 30 such that the contacts 38 of the extension block 18 align with the contacts 13 of the circuit board 12, as illustrated in FIG. 8.

In order to form a permanent connection between the extension block 18 and FPCBA 10, ultrasonic energy is used to heat the tin-bismuth solder blobs above their reflow temperatures. Using tin-bismuth solder allows the components to be reflowed at a lower temperature than its melting temperature (approx. 139° C.), which does not damage the materials of the card body 22. Tin-bismuth solder is sufficiently conducive to provide the connection needed for the contact pad 20 to communicate with the secure element 16 and the other components 14 of the FPCBA 10.

Next, the contact pad 20 is connected to the extension block 18. Again, a tin-bismuth solder is used to form solder blobs 34 on the top contacts 36 of the extension block 18. The contact pad 20 is then inserted into the cavity 30 such that the upper contacts 36 of the extension block 18 align with the contacts 21 of the contact pad 20, as illustrated in FIG. 9. Ultrasonic energy is again used to heat the tin-bismuth solder blobs 34 above their reflow temperatures to form a permanent bond between the contact pad 20 and the extension block 18.

FIGS. 10 and 11 illustrate the assembled card 102 where the contact pad 20 is thus electrically connected to the secure element 16 via the extension block 18. Furthermore, the extension block 18 supports the contact pad 20 at the correct height such that it is flush with the front surface of the smart card body 22.

In accordance with a second method of manufacture, a card body 22 having a cavity 30 is formed in the same manner as in the first embodiment (as illustrated in FIGS. 6 and 7). However, in the second method of manufacture, the extension block 18 and contact pad 20 are connected before being inserted into the cavity 30 in the laminated card body 22.

In order connect the extension block 18 to the contact pad 20, solder blobs are formed on the top contacts 36 of the extension block 18. The contact pad 20 is then placed on top of the extension block 18 such that the top contacts 36 of the extension block 18 align with the contacts 21 of the contact pad 20, as shown in FIGS. 12 and 13.

Unlike the first method of manufacture, there is no need to use a solder with a melting temperature below that of the materials of the card body to connect the extension block 18 and contact pad 20. By connecting the extension block 18 and contact pad 20 before inserting them in the cavity 30, any suitable solder material can be used. Furthermore, the connection between the extension block 18 and contact pad 20 can be inspected to ensure good contact.

To install the extension block 18 and contact pad 20 into the smartcard, a tin-bismuth solder is used to form solder blobs on the rear contacts 38 of the extension block 18. The extension block 18 and contact pad 20 are then inserted into the cavity 30 such that the contacts 38 of the extension block 18 align with the contacts 13 of the circuit board 12, as shown in FIG. 14.

In order to form a permanent connection between the extension block 18 and FPCBA 10, ultrasonic energy is used to heat the tin-bismuth solder blobs above their reflow temperatures. Using tin-bismuth solder allows the components to be reflowed at a lower temperature than its melting temperature (approx. 139° C.), which does not damage the materials of the card body 22. Tin-bismuth solder is sufficiently conducive to provide the connection needed for the contact pad 20 to communicate with the secure element 16 and the other components 14 of the FPCBA 10.

In the assembled card 102 the contact pad 20 is thus electrically connected to the secure element 16 via the extension block 18. Furthermore, the extension block 18 supports the contact pad 20 at the correct height such that it is flush with the front surface of the card body 22.

In both the first and second methods of manufacture, where an electrical connection is made after the card body 22 has been formed, it is preferable for a formation temperature (e.g. a curing temperature, or a melting temperature, or a reflow temperature) of the electrical connection, e.g. between the contact pad 20, extension block 18 and FPCBA 10, to be lower than a melting temperature of the material of the card body 22. Thus, forming the electrical connection will not cause deformation of the card body 22. It is anticipated, that to achieve this, the electrical connection will have a formation temperature below 150° C., and preferably below 140° C.

For example, most typical solders must be heated to temperatures of over about 240° C. to become molten, whereas polyvinyl chloride (PVC), which is the most common material used to produce laminated cards, has a melting temperature of only 160° C. (and a glass transition temperature of only 80° C.). Polyurethane (PU), which is also commonly used as filler for laminated cards, would also be damaged by exposure to temperatures in the region of 240° C.

To avoid overheating the card body materials, a low melting temperature solder is used. The use of a low temperature electrical connection avoids any physical deformation of the card material.

Alternatively (not shown), a conductive adhesive may be used to conductively join the contact pad 20 and the FPCBA 10 to the extension block 18. The conductive adhesive would preferably have a curing temperature below the melting temperature of the material forming the card body 22. Exemplary conductive adhesives include conductive epoxies, and in one preferred embodiment the connection comprises an anisotropic conductive film (ACF). However, other non-melting conductive resins may of course be used to provide the electrical connections.

A further alternative connection (not shown) would be a mechanical connection to conductively join the contact pad 20 and the FPCBA 10 to the extension block 18. A mechanical connection such as a connection via surface mount technology does not typically require heating. This has the advantage of not requiring thermal or physio-chemical processes, and enables room temperature manufacturing with no preparation or wait times. One exemplary mechanical connection is an elastomeric connector (sometimes known as a Zebra connector®). The elastomeric connector comprises mated male and female terminals, each having alternating conductive and non-conductive stages that engage the respective stages of the corresponding terminal.

Alternatively, a mechanical connection may comprise embedded conductive stubs that are configured to deform so as to conform to the surface of the extension block 18. The stubs may be configured to press into the through holes 34 formed in the extension block 18 so as to electrically connect with the contacts 36, 38. The stubs may be made of carbon, silver or copper. Alternatively, the stubs may be formed of a solder material such that they can be pressed into engagement (e.g. into the through holes 34) and then heated to cause the solder to reflow forming a permanent connection.

FIGS. 15 to 17 show a third method of manufacture of smartcard 102, which is a variation of the first and second methods discussed above. Components corresponding to those discussed in relation to the first and second embodiments share the same reference numeral, incremented by 100. To avoid repetition, only the differences between these methods will be discussed below. The discussion of the components in relation to the first and second methods otherwise applies to the corresponding components discussed below in relation to the third method.

In the third method of manufacture, the extension block 118 and contact pad 120 are installed pre-lamination and the card body 122 is laminated after the contact pad 120 and the extension block 118 are connected to the FPCBA 110. Solder is used to form solder blobs 134 on the top contacts 136 of the extension block 118. The contact pad 120 is then placed on top of the extension block 118 such that the top contacts 136 of the extension block 118 align with the contacts 121 of the contact pad 120.

Next, the extension block 118 is connected to the FPCBA 110. Again, solder is used to form solder blobs 134 on the rear contacts 138 of the extension block 118. The extension block 118 is then placed on top of the FPCBA 110 such that the contacts 138 of the extension block 118 align with the contacts 113 of the circuit board 112, as illustrated in FIG. 15.

The FPCBA 110 is then encased in polyurethane (PU) filler 124 and sandwiched between two polyvinyl chloride (PVC) sheets 126, 128. The two PVC sheets 126, 128 each have a thickness of approximately 80 μm and the intermediate layer formed by the FPCBA 110 and the PU filler 124 has a thickness of approximately 540 μm. A hole is cut in the upper PVC sheet 128 such that the contact pad 120 is exposed when the PVC sheet 128 is placed on the surface of the PU filler 124 prior to lamination.

The pre-laminated card body is then compressed and heated to a temperature between 160° C. and 190° C. to form a single, laminated card body 122, as shown in FIG. 16.

The solder used to connect the contact pad 120 to the extension block 118, and the extension block 118 to the FPCBA 110 must be sufficiently conductive to provide the connection needed for the contact pad to communicate with the secure element 116 and the other components 114 of the FPCBA. The solder must also have a melting temperature above the temperatures used to laminate the card body 122 so that the solder does not melt during the lamination process.

During the lamination process, some of the upper PVC sheet 128 may melt to form a thin layer of lamination covering the contact pad 120, which may impede electrical connection to the card. Any lamination material that may have melted over the contact pad 120 is removed by cutting a hole in the laminated card body 122 over and around the contact pad 120. The lamination material is removed from the surface of the contact 120 pad such that it is exposed on the surface of the card body 122, as shown in FIG. 17.

In the assembled card the contact pad 120 is electrically connected to the secure element 116 via the extension block 118. Furthermore, the extension block 118 supports the contact pad 120 at the correct height such that it is flush with the front surface of the card body 122.

We claim:

1. A smartcard comprising:
a card body enclosing a flexible circuit;
a contact pad having contacts exposed from the card body;
an extension block located within the card body between the contact pad and the flexible circuit, the extension block defining conductive paths therethrough such that the contacts of the contact pad are electrically connected to the flexible circuit via the conductive paths; and
a secure element located within the card body and electrically connected to the flexible circuit, wherein the secure element does not overlap with the contact pad.

2. A smartcard according to claim 1, wherein the extension block has a height of at least 200 μm.

3. A smartcard according to claim 1, wherein the extension block comprises a block of electrically-insulating material defining a plurality of through holes, wherein the conductive paths extend via the through holes.

4. A smartcard according to claim 1, wherein the extension block is electrically connected to the contacts of the flexible circuit and/or the contacts of the contact pad by one of a mechanical connection, a conductive adhesive connection, and a metallic solder connection.

5. A smartcard according to claim 1, wherein the smartcard further comprises a biometric authentication module, the biometric authentication module being configured to authenticate the identity of a bearer of the smartcard, and to command the secure element of the smartcard to transmit data responsive to authentication of the bearer of the card.

6. A smartcard according to claim 1, wherein the smartcard comprises an antenna configured to communicate with the secure element.

7. A smartcard according to claim 1, wherein the card body is formed from a plastics material, and comprises polyvinyl chloride (PVC) and/or polyurethane (PU).

8. A method of manufacturing a smartcard comprising:
providing a flexible circuit having contacts for connection to a contact pad, and configured for connection to a secure element;
electrically connecting contacts on a contact pad to the contacts on the flexible circuit board via conductive paths through an extension block;
electrically connecting a secure element to the flexible circuit board such that the secure element does not overlap with the contact pad; and
applying a lamination process to the flexible circuit to provide a card body enclosing the flexible circuit.

9. A method according to claim 8, further comprising:
electrically connecting the extension block to the contact pad before electrically connecting the extension block to the flexible circuit board.

10. A method according to claim 8, further comprising removing lamination material from the card body to expose the surface of the contact pad.

11. A method according to claim 8, wherein the method further comprises electrically connecting a biometric authentication module to the flexible circuit, the biometric authentication module being configured to authenticate the identity of a bearer of the smartcard, and to command the secure element of the smartcard to transmit data responsive to authentication of the bearer of the smartcard.

12. A method according to claim 8, wherein the lamination process is a thermal lamination process applied at a temperature of at least 150° C.

13. A method of manufacturing a smartcard comprising:
providing a card body enclosing a flexible smartcard circuit having contacts for connection to a contact pad, wherein a secure element is located within the card body and electrically connected to the flexible circuit, and wherein a cavity is formed in the card body exposing the contacts;
inserting into the cavity an extension block that defines paths therethrough and a contact pad having contacts; and
electrically connecting the contacts on the contact pad to the contacts on the flexible circuit via the paths of the extension block.

14. A method according to claim 13, further comprising:
electrically connecting the extension block to the contact pad before inserting the extension block and the contact pad into the cavity.

15. A method according to claim 13, wherein electrically connecting the contacts comprises forming a metallic solder connection.

16. A method according to claim 13, wherein the electrical connection comprises a mechanical connection or a conductive adhesive connection.

17. A method according to claim 13, wherein the step of providing the card body comprises removing material from the card body to create the cavity and expose the contacts.

18. A method according to claim 13, further comprising applying a lamination process to the card body after electrically connecting the contacts on the contact pad to the contacts on the flexible circuit via the paths of the extension block.

19. A method according to claim 13, wherein the step of providing the card body comprises forming the card body by a lamination process.

20. A smartcard according to claim 1, wherein the extension block has a height of at least 300 μm.
